(19) United States
(12) Patent Application Publication
(10) Pub. No.: US 2011/0122363 A1
(43) Pub. Date: May 26, 2011

(54) ANTI-GLARE OPTICAL ELEMENT AND OPTICAL DEVICE USING THE SAME

(75) Inventors: CHAO-TSANG WEI, Tu-Cheng (TW); GA-LANE CHEN, Santa Clara, CA (US)

(73) Assignee: HON HAI PRECISION INDUSTRY CO., LTD., Tu-Cheng (TW)

(21) Appl. No.: 12/943,942

(22) Filed: Nov. 11, 2010

(30) Foreign Application Priority Data
Nov. 25, 2009 (CN) 200910310365.3

(51) Int. Cl. G02C 7/12; G02B 5/30

(52) U.S. Cl. 351/49; 359/488.01; 977/742; 977/834; 977/750; 977/752

(57) ABSTRACT

An optical element includes a base and an anti-glare layer. The base has a surface. The anti-glare layer is positioned on the surface and includes carbon nanotubes. The carbon nanotubes are arranged substantially parallel to each other and configured to absorb an S-polarized light that irradiates the surface.

### BACKGROUND

1. Technical Field

The present disclose is related to optical elements, and particularly to an anti-glare optical element utilizing carbon nanotubes and an optical device using the same.

2. Description of Related Art

Polarized light can be separated into S-polarized light and P-polarized light. In general, unwanted glare is caused by polarized light, especially S-polarized light.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic diagram of an embodiment of an optical device.

FIG. 2 is a schematic diagram of an optical element of the optical device of FIG. 1, the optical element including an anti-glare layer.

FIG. 3 is a schematic diagram of one embodiment of the anti-glare layer.

FIG. 4 is a schematic diagram of another embodiment of the anti-glare layer.

FIG. 5 is a schematic diagram of a light path of the anti-glare layer.

### DETAILED DESCRIPTION

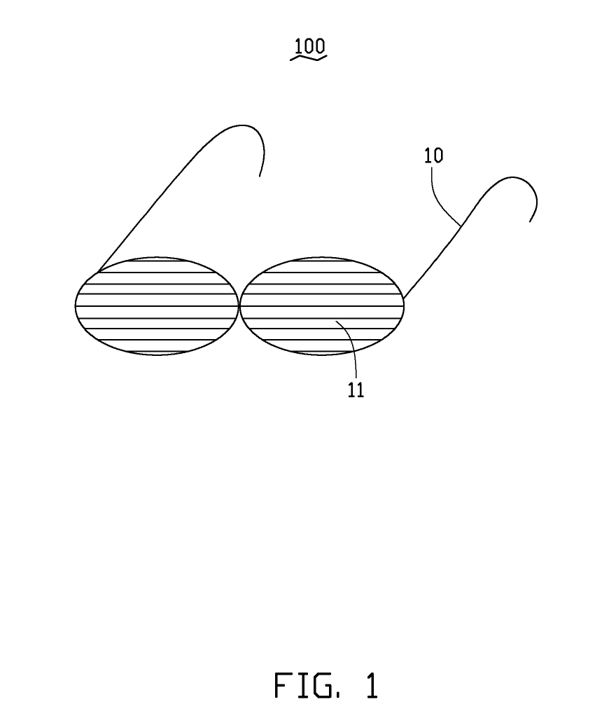

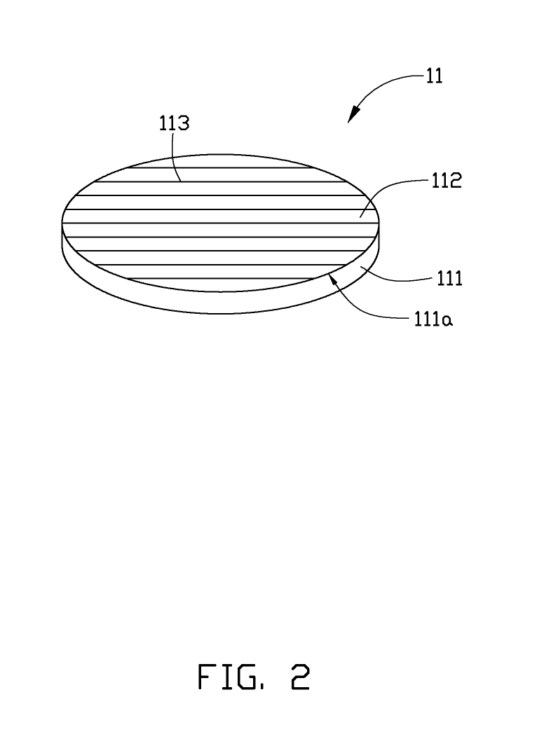

Referring to FIGS. 1 and 2, an embodiment of an optical device 100 includes a body 10 and an optical element 11 received in the body 10. The optical device 100 may be sunglasses, a camera, architectural glass or windshield glass. In the illustrated embodiment, the optical device 100 is a pair of sunglasses, and the body 10 is a frame receiving the optical element 11 such as a lens thereof

The optical element 11 includes a base 111 and an anti-glare layer 112. The base 111 can be made of glass material or plastic material, such as Polyethyleneterephthalate (PET). In the illustrated embodiment, the base 111 is a glass lens. The base 111 has a surface 111a.

The anti-glare layer 112 is positioned on the surface 111a of the base 111, and includes a plurality of carbon nanotubes 113. The carbon nanotubes 113 are arranged on the surface 111a of the base 111 substantially parallel to each other. Each carbon nanotube 113 can be a single-wall carbon nanotube or a multi-wall carbon nanotube. The thickness of the anti-glare layer 112 can be in a range from about 0.5 nm to about 100 mm.

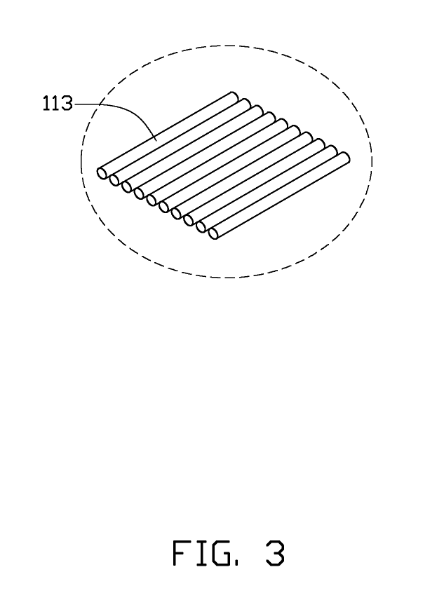

Referring to FIG. 3, one embodiment of the anti-glare layer 112 includes a carbon nanotube film. The carbon nanotube film can be formed by stretching a carbon nanotube matrix having a plurality of carbon nanotubes and is coated on the surface 111a of the base 111 by self-adhesive. As should be noted, a part of the carbon nanotubes 113 of the film align end-to-end by Van der Waals force.

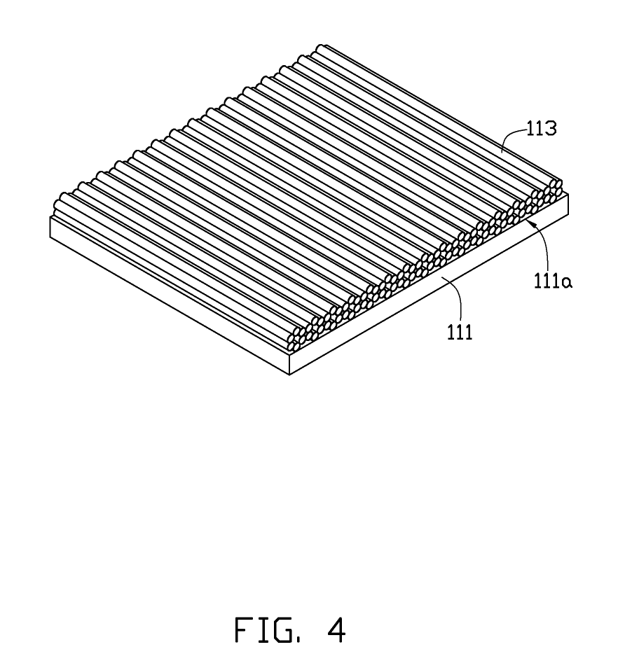

Referring to FIG. 4, another embodiment of the anti-glare layer 112 includes a plurality of carbon nanotube linear structures. In one embodiment, the carbon nanotube linear structure can be formed by stretching a carbon nanotube matrix having a plurality of carbon nanotubes. The carbon nanotube linear structures are substantially parallel to each other. A gap may be defined between the adjacent linear portions. In another embodiment, the carbon nanotube linear structure can be formed by using an organic solvent to combine the carbon nanotube films together.

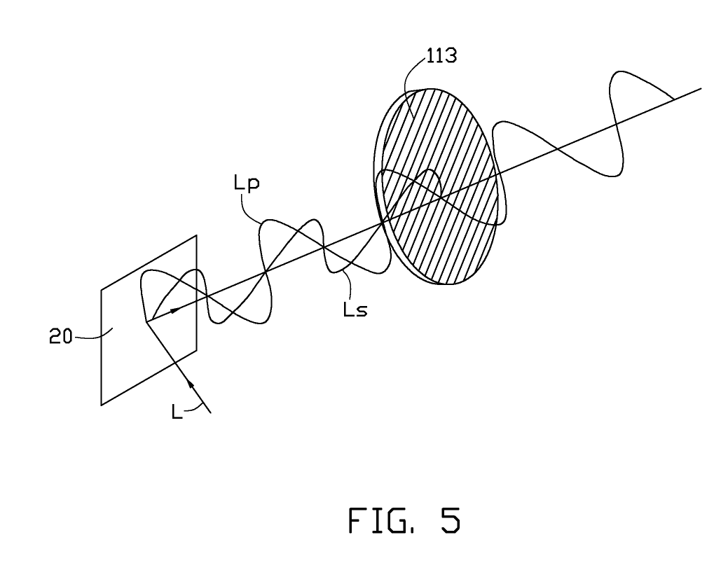

Referring to FIG. 5, light L is emitted onto a smooth surface 20, and separated into S-polarized light Ls and P-polarized light Lp when reflected therefrom. The S-polarized light Ls and the P-polarized light Lp are transmitted to the carbon nanotubes 113. The carbon nanotubes 113 are arranged substantially parallel to an oscillation direction (also referred to as polarization axis) of the electronic field of the S-polarized light Ls. As a result, the most electrons of the S-polarized light Ls are absorbed by the carbon nanotubes 113, and the P-polarized light Lp is transmitted through the carbon nanotubes 113.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. An optical element, comprising:
a base having a surface; and
an anti-glare layer positioned on the surface and comprising a plurality of carbon nanotubes, wherein the carbon nanotubes are substantially parallel to each other and configured to absorb a S-polarized light that irradiates the surface.

2. The optical element of claim 1, wherein the base is made of polyethyleneterephthalate.

3. The optical element of claim 1, wherein the base is a glass lens.

4. The optical element of claim 1, wherein the carbon nanotubes are single-walled carbon nanotubes.

5. The optical element of claim 1, wherein the carbon nanotubes are multi-walled carbon nanotubes.

6. The optical element of claim 1, wherein the carbon nanotubes are formed in a film.

7. The optical element of claim 1, wherein the carbon nanotubes are formed in a plurality of linear structures

8. The optical element of claim 6, wherein a part of the carbon nanotubes of the film is aligned end-to-end by Van der Waals force.

9. The optical element of claim 7, wherein the linear structures are substantially parallel to each other.

10. The optical element of claim 1, wherein the thickness of the anti-glare layer is in a ranged from about 0.5 nm about 100 mm.

11. An optical device, comprising:
a body; and
an optical element contained in the body, the optical element comprising:
a base having a surface; and
an anti-glare layer positioned on the surface and comprising a plurality of carbon nanotubes arranged substantially parallel to one another, wherein the carbon nanotubes are configured to absorb a S-polarized light that irradiates the surface.

12. The optical device of claim 11, wherein the base is made of polyethyleneterephthalate.

13. The optical device of claim 11, wherein the base is a glass lens.

14. The optical device of claim 11, wherein the carbon nanotubes are formed in a film.

15. The optical device of claim 11, wherein the carbon nanotubes are formed in a plurality of linear structures.

16. The optical device of claim 14, wherein a part of the carbon nanotubes of the film is aligned end-to-end by Van der Waals force.

17. The optical device of claim 15, wherein the linear structures are substantially parallel to each other.

18. The optical device of claim 11, wherein the thickness of the anti-glare layer is in a ranged from about 0.5 nm about 100 mm.

19. Sunglasses, comprising:
a frame; and
two lenses positioned on the frame, each of the lenses having a surface, and an anti-glare layer being positioned on the surface, wherein the anti-glare layer comprises a plurality of carbon nanotubes, and the carbon nanotubes are arranged substantially parallel to each other and configured to absorb a S-polarized light that irradiates the surface.

20. The sunglasses of claim 19, wherein the thickness of the anti-glare layer is in a ranged from about 0.5 nm about 100 mm.
